(19) United States
(12) Patent Application Publication
(10) Pub. No.: US 2017/0308664 A1
(43) Pub. Date: Oct. 26, 2017

(54) APPARATUS AND SOFTWARE PROGRAM FOR DOCUMENTING CARDIAC LIFE SUPPORT PROCEDURES DURING A CODE BLUE EVENT

(71) Applicants: NAWAR N. FARAJ, ROANOKE, VA (US); ROBERT G. REVNIC, RICHMOND, VA (US); LOUIS B. SAKWE, CHESTER, VA (US)

(72) Inventors: NAWAR N. FARAJ, ROANOKE, VA (US); ROBERT G. REVNIC, RICHMOND, VA (US); LOUIS B. SAKWE, CHESTER, VA (US)

(21) Appl. No.: 15/138,386

(22) Filed: Apr. 26, 2016

(51) Int. Cl. G06F 19/00; G06F 3/0482; G06F 3/0484; G06F 3/0488

(52) U.S. Cl. CPC G06F 19/3406; G06F 3/04886; G06F 3/0482; G06F 3/04847

(57) ABSTRACT

An apparatus for documenting Advanced Cardiac Life Support (ACLS) procedures during a code blue event is disclosed. The apparatus includes a touch screen display, a processor, and electronic memory storage including instructions executable by the processor. The instructions, processor, and touch screen display a plurality of buttons used to record times at which a medication and/or action of the ACLS protocol was administered. The actuation of a medication button further results in a change in the visual appearance of the medication button. A summary button is provided to display a summary page including at least a start time of the code blue event, and times at which medications for the ACLS procedure were administered.

### FIELD OF THE INVENTION

The present invention relates to Advanced Cardiac Life Support procedures, and more particularly to apparatus and methods used in documenting cardiac life support procedures during a code blue event.

### BACKGROUND

Healthcare employees, nurses, and physicians must overcome obstacles that occur when a patient is in cardiopulmonary arrest and ‘codes’, otherwise known as a code blue event. A code blue event is an emergency announced in a hospital during which a patient is in cardiopulmonary arrest, requiring a team of providers to rush to the patient and begin immediate resuscitative efforts. When this occurs, the scene can be hectic, and it can be difficult to coordinate medication administration and proper documentation.

Advanced Cardiac Life Support (ACLS) procedures are executed by the emergency team during the code blue event. ACLS refers to a set of clinical interventions for the urgent treatment of cardiac arrest, stroke, and other life-threatening medical emergencies. Only qualified health care providers can provide ACLS, as it requires the ability to manage the patient's airway, initiate IV access, read and interpret electrocardiograms, and understand emergency pharmacology.

Hospitals and other healthcare facilities mandate the documentation of the ACLS procedures that take place during a code blue event. Usually, one of the qualified health care providers involved in the code blue response is designated to monitor the procedures. Nurses and physicians must manually keep track of what time lifesaving interventions (medication type, medication dosage, intubation, CPR, etc.) occur. This information must be later transferred to official hospital records. The process is time consuming, and can sometimes lead to errors. Further, much of the time used to monitor the ACLS procedures could be beneficially used by an emergency team member to participate in the administration of the ACLS procedures, but for the time consumed in monitoring the ACLS procedures.

### SUMMARY

One general aspect of the invention is an apparatus for documenting Advanced Cardiac Life Support (ACLS) procedures during a code blue event. The apparatus includes a touch screen display, a processor, and electronic memory storage including instructions executable by the processor. The instructions, processor, and touch screen display cooperate to provide a code blue event start button on the touch screen display. Actuation of the event start button records a start time of the code blue event in the electronic memory storage. The components also cooperate to provide a plurality of medication buttons on the touch screen display, the plurality of medication buttons corresponding to respective medications administered as part of an ACLS procedure. Actuation of a medication button records a time at which the respective medication was administered. The actuation of the medication button further results in a change in a visual appearance of the medication button. A summary button is provided on the touch screen display. Actuation of the summary button displays a summary page including at least a start time of the code blue event and times at which medications for the ACLS procedure were administered.

Implementations of the invention may include embodiments having one or more of these features. The apparatus where the change in visual appearance of the medication button includes displaying a number of times the respective medication has been delivered. The apparatus where actuation of the medication button starts a timer indicating when a next dose of the respective medication may be administered. The apparatus where the visual appearance of the medication button changes when a next dose of the respective medication may be administered. The apparatus where the visual appearance of the medication button shows an amount of the respective medication to be administered as the next dose in the ACLS procedure. The apparatus where visual indicia corresponding to the timer is displayed proximate the medication button. The apparatus where the instructions and the processor further cooperate to interact with the touch screen display to: provide a plurality of action buttons on the touch screen display, the plurality of action buttons corresponding to respective actions taken as part of the ACLS procedure, actuation of an action button recording a time at which the respective action was taken as part of the ACLS procedure, where actuation of the summary button on the touch screen display accesses times at which the respective actions were taken. The apparatus where at least one action button includes visual indicia corresponding to an elapsed time since actuation of the at least one action buttons. The apparatus where the plurality of action buttons include a CPR/pulse check button, an airway intubation button, a defibrillate button, and/or a cardioversion button. The apparatus where the apparatus wirelessly transmits at least a portion of data included in the summary page to another device. The apparatus where the apparatus emails at least a portion of data included in the summary page. The apparatus where the code blue event start button includes visual indicia corresponding to elapsed time of the code blue event. The apparatus where the code blue start event button and plurality of medication buttons are all displayed on a single page of the touch screen display.

Another general aspect of the invention is a software program for documenting Advanced Cardiac Life Support (ACLS) procedures during a code blue event. The software program includes instructions executable by a processor, where the instructions and the processor cooperate to interact with a touch screen display to provide a code blue event start button on the touch screen display, actuation of the code blue event start button recording a start time of the code blue event in electronic memory storage, actuation of the code blue event further displaying visual indicia indicative of an elapsed time since the start time of the code blue event. A plurality of medication buttons are presented on the touch screen display corresponding to respective medications administered as part of an ACLS procedure, actuation of a medication button records a time at which the respective medication was administered in the electronic memory storage, where the actuation of the medication button further results in a change in a visual appearance of the medication button. The software also presents, on the touch screen display, a summary button, actuation of the summary button accessing the electronic memory storage to display a summary page including at least a start time of the code blue event and times at which medications for the ACLS procedure were administered.

Implementations of the invention may include embodiments having one or more of these features. The software where the instructions and the processor further cooperate to interact with the touch screen display to: provide a plurality of action buttons on the touch screen display, the plurality of action buttons corresponding to respective actions taken as part of the ACLS procedure, actuation of an action button recording a time at which the respective action was taken as part of the ACLS procedure in the electronic memory storage, wherein actuation of the summary button on the touch screen display accesses times at which the respective actions were taken from the electronic memory storage. The software program where at least one action button includes visual indicia corresponding to an elapsed time since actuation of the at least one action button.

Another general aspect of the invention is a method for documenting Advanced Cardiac Life Support (ACLS) procedures during a code blue event. The method comprises: actuating a code blue event start button on a touch screen display, actuation of the code blue event start button recording a start time of the code blue event in electronic memory storage; actuating a plurality of medication buttons on the touch screen display, the plurality of medication buttons corresponding to respective medications administered as part of the ACLS procedure, actuation of a medication button recording a time at which the respective medication was administered in the electronic memory storage, where the actuation of the medication button further results in a change in a visual appearance of the medication button; and actuating a summary button on the touch screen display, actuation of the summary button accessing the electronic memory storage to provide a summary page including at least a start time of the code blue event and times at which medications for the ACLS procedure were administered.

The invention allows information to be more efficiently transferred to official hospital records than current procedures, helping to save time and reduce errors. Further, the invention allows much of the time presently used to monitor the ACLS procedures to be beneficially used by an emergency team member to participate more in the administration of the ACLS procedures.

### BRIEF DESCRIPTION OF THE DRAWINGS

For a fuller understanding of the invention, reference is made to the following Detailed Description, taken in conjunction with the accompanying drawings, in which:

FIG. 1 is a block diagram of an apparatus for documenting Advanced Cardiac Life Support (ACLS) procedures during a code blue event.

FIG. 2 is an example of a screen that may be displayed before the start of a code blue event.

FIG. 3 is a flowchart showing one example of the operations that may be executed when the start button is actuated in response to a code blue event.

FIG. 4 is an example of a screen that may be displayed in response to the operations of the flowchart shown in FIG. 3.

FIG. 5 is a flowchart showing one example of the operations that may be executed when a medication button is actuated in response to administration of the corresponding medication.

FIG. 6 is an example of a screen that may be displayed in response to various operations implemented in the flowchart shown in FIG. 5.

FIG. 7 is an example of a screen shot that may be displayed in response to various operations implemented in the flowchart shown in FIG. 5.

FIG. 8 is a flowchart showing one example of the operations that may be executed when an action button is actuated in response to application of the corresponding action.

FIG. 9 is an example of a screen shot that may be displayed in response to various operations implemented in the flowchart shown in FIG. 8.

FIG. 10 is a flowchart showing a further example of the operations that may be executed when a medication button is actuated in response to administration of the corresponding medication.

FIG. 11 is an example of how the visual appearance of a button may change in response to various operations implemented in the flowchart shown in FIG. 10.

FIG. 12 is a flowchart showing a further example of the operations that may be executed when a medication/action button is actuated in response to administration of the corresponding medication and/or action.

FIG. 13 is an example of a screen that may be displayed in response to various operations implemented in the flowchart shown in FIG. 12.

FIG. 14 is an example of a screen that may be displayed in response to a long press of the Start key as implemented in the flowchart shown in FIG. 1.

FIG. 15 is a flowchart showing one manner in which the system may respond to actuation of the summary button.

### DETAILED DESCRIPTION

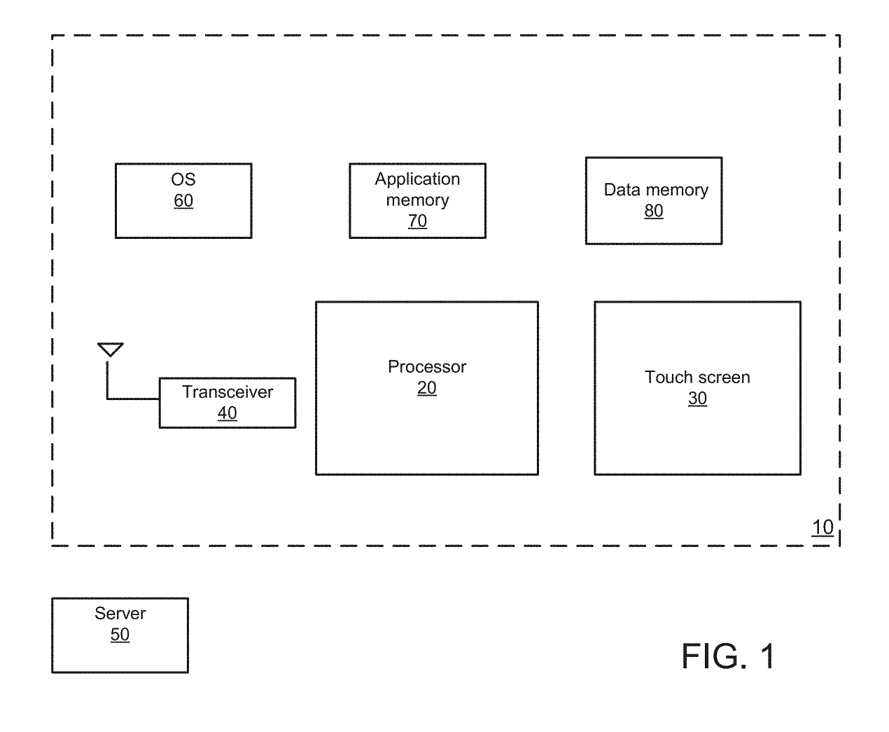

FIG. 1 is a block diagram of a system 10 for documenting Advanced Cardiac Life Support (ACLS) procedures during a code blue event. The system 10 may be a smart device, such as a tablet, smart phone, touch screen computer, or the like. In this example, the system 10 includes one or more processors 20 that execute a software application. A touch screen 30 accepts user input selections and displays screen shots for the software application. A transceiver 40 may be provided to transmit data to and receive data from one or more servers 50 over a wireless network, wired network, etc. The server 50 may be a cloud server, a local network server, etc.

The processor 20 is configured to access one or more local storage devices. The local storage devices may comprise a single memory component or multiple memory components used to store software in the form of executable application code, executable operating system code, application data, etc. The local storage device(s) are accessible by the processor(s).

In the example of FIG. 1, the system 10 includes various functional memory storage areas. Here, the functional memory storage areas include the operating system 60, the application memory 70, and the data memory 80. The application memory 70 in this example stores a mobile application having a plurality of modules executable by the processor 20 for documenting the ACLS procedures during the code blue event. The data generated by the application is stored in data memory 80. The application memory 70 may also include modules to execute other mobile applications.

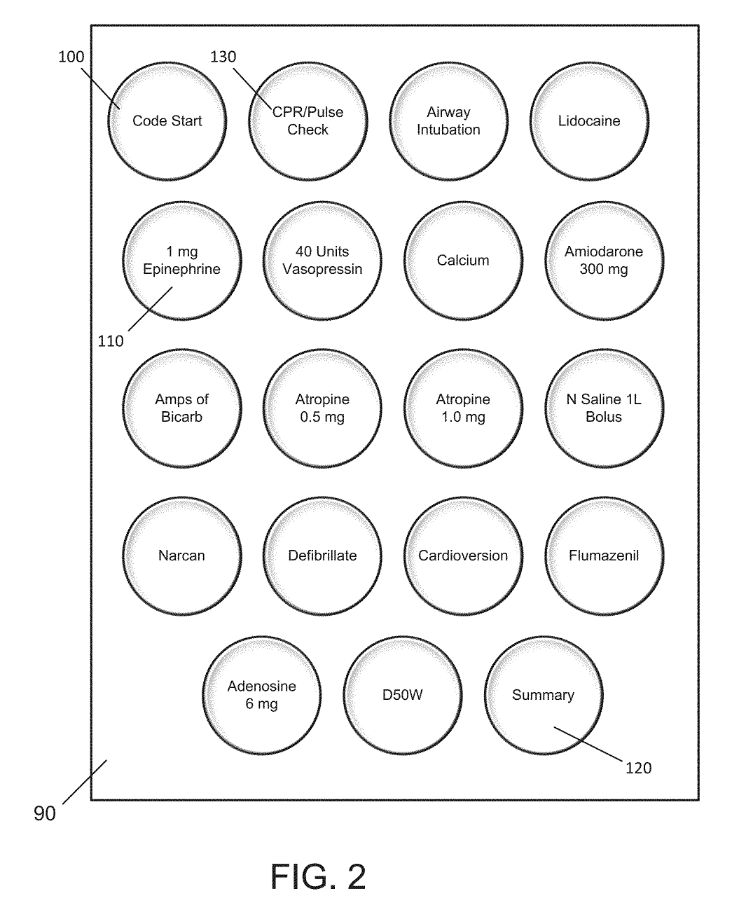

FIG. 2 is a screen 90 that may be displayed before the start of a code blue event once the application has been initialized. In this example, the screen includes a code blue event start button 100, a plurality of medication buttons (e.g., 1 mg epinephrine button 110), and a summary button 120. The plurality of medication buttons includes, for example, all medications that are used in the standard ACLS procedure. The screen 90 may also include a plurality of action buttons (e.g., CPR/Pulse check button 130) corresponding to specific actions taken during the standard ACLS procedure. Since the ACLS standards evolve over time, the specific medication buttons and action buttons on screen 90 may be changed to correspond to the current ACLS standards. Although the medication and action buttons may be displayed on separate pages, they are all displayed on a single page in FIG. 2 to simplify access to them.

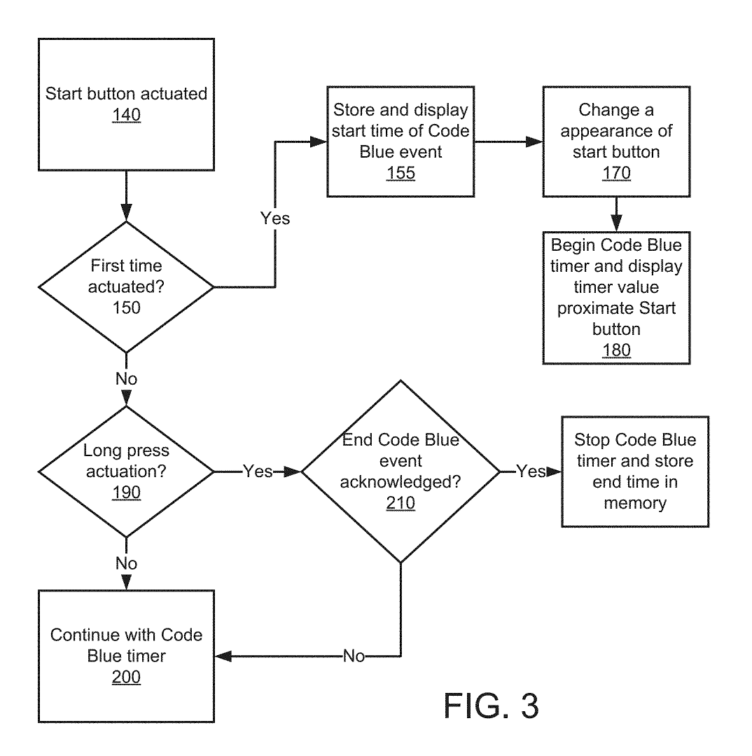

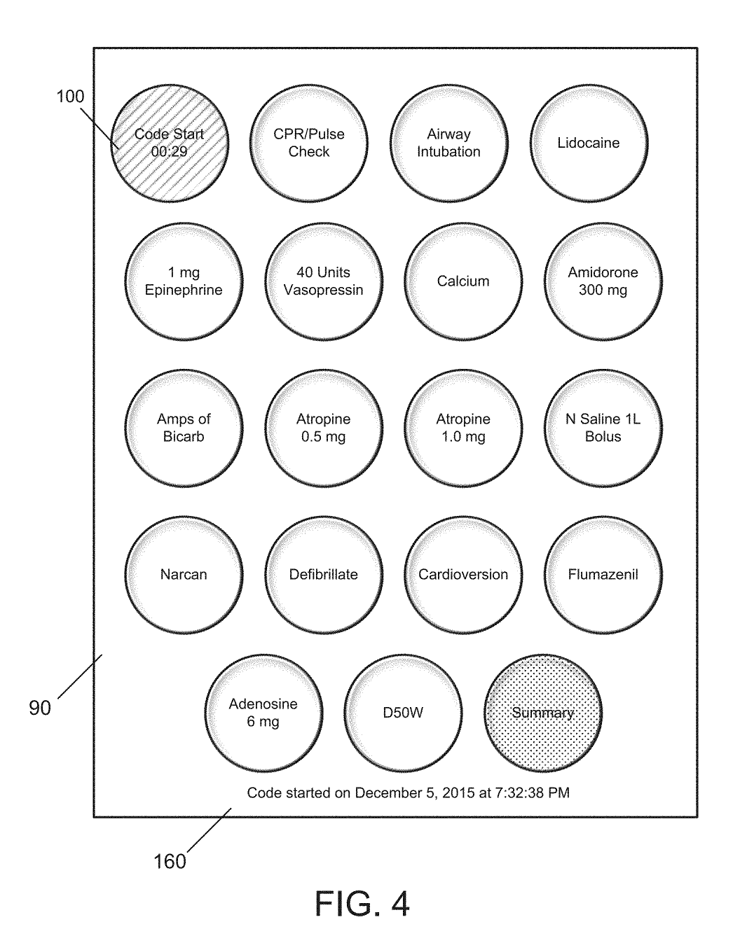

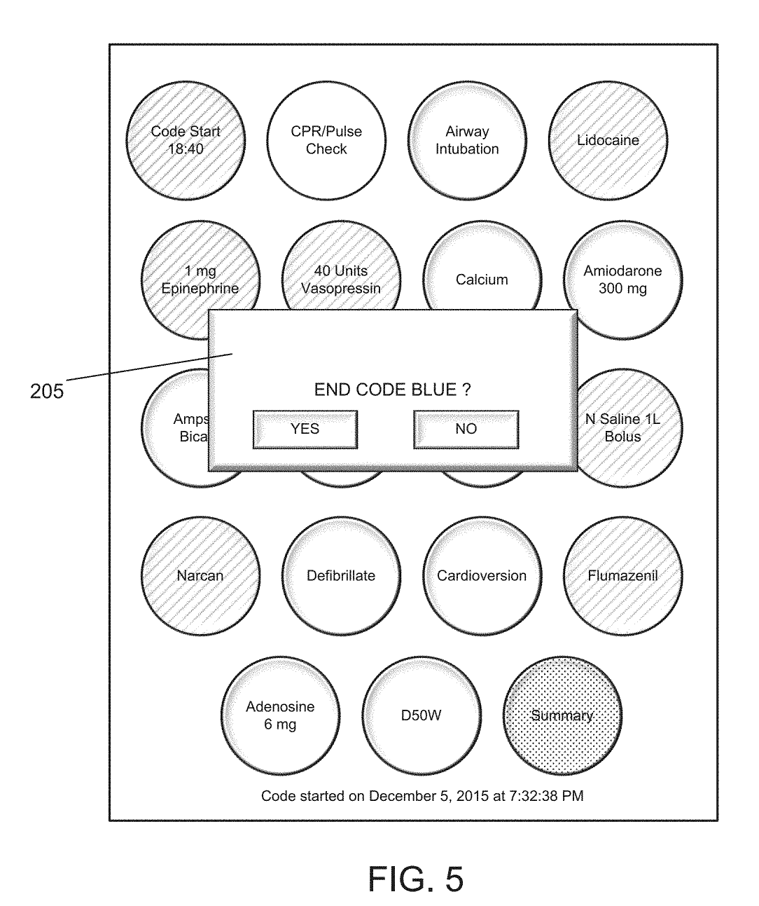

Documentation of a code blue event includes recording the start and end times of the event. FIG. 3 is a flowchart of one example of the operations that may be executed by the system 10 when the start button 100 is actuated in response to the start of a code blue event. FIG. 4 is an example of a screen that may be displayed in response to the operations shown in the flowchart of FIG. 3.

As shown, the user actuates the start button 100 at operation 140 when the code blue event begins. At operation 150, a check is made whether this is the first time the start button 100 has been actuated. If it is the first time, the start of the code blue event and its corresponding start time are stored at operation 155 and the start time is displayed at the bottom of screen 90 at area 160. The appearance of the start button 100 is changed at operation 170 to indicate that the code blue event has started (see also FIG. 4). The appearance may be changed in any manner so long as it serves as a visual indication to the emergency team that it has been actuated. For example, the start button 100 may change color, fill style, text style, etc. The code blue timer is started at operation 180 and the value of the elapsed time of the code blue event is displayed on the start button 100 as shown in FIG. 4.

If it is decided at operation 150 that the start button 100 has been previously actuated, the system 10 determines whether it was pressed accidentally or pressed to signal the end of the code blue event. To this end, a check is made at operation 190 whether the emergency team pressed the start button 100 as a long press. If a long press was not detected, it is assumed that the activation of the start button was accidental and the system 10 continues forward without interrupting the timer at operation 200. If a long press has been detected, however, a selection box 205 is displayed to allow the emergency team to acknowledge the end of the code blue event. If the emergency team acknowledges the end of the event, the code blue timer is stopped and the end time is stored in memory at operation 220. If the user indicates that the code blue event has not ended at operation 210, the system will continue to operation 200.

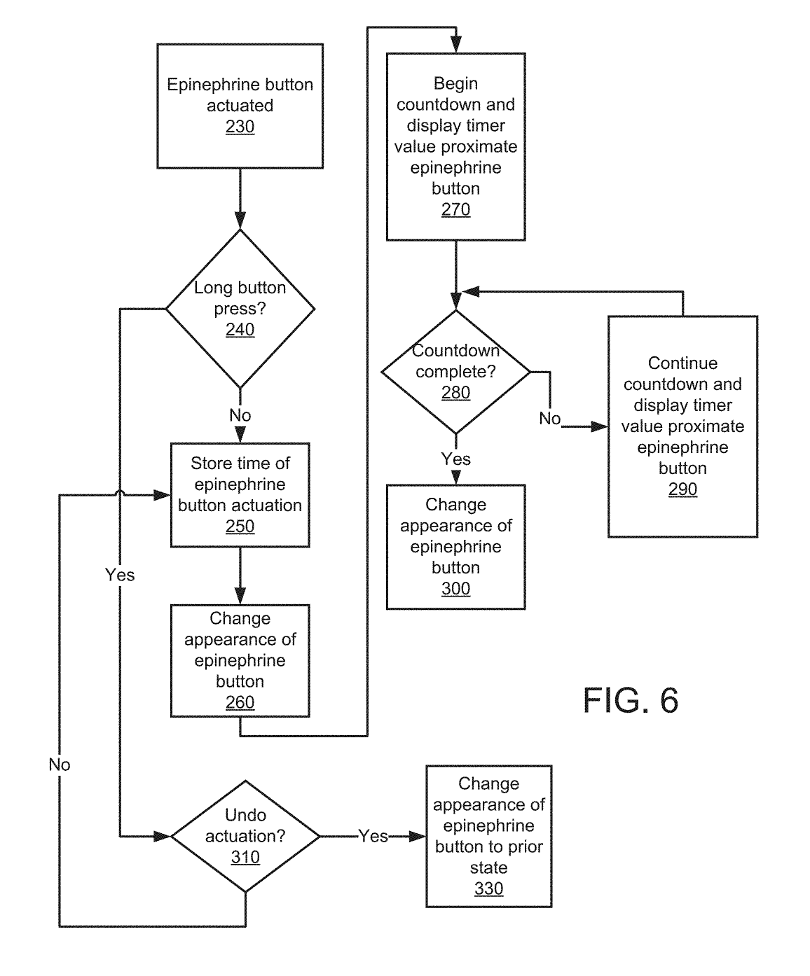

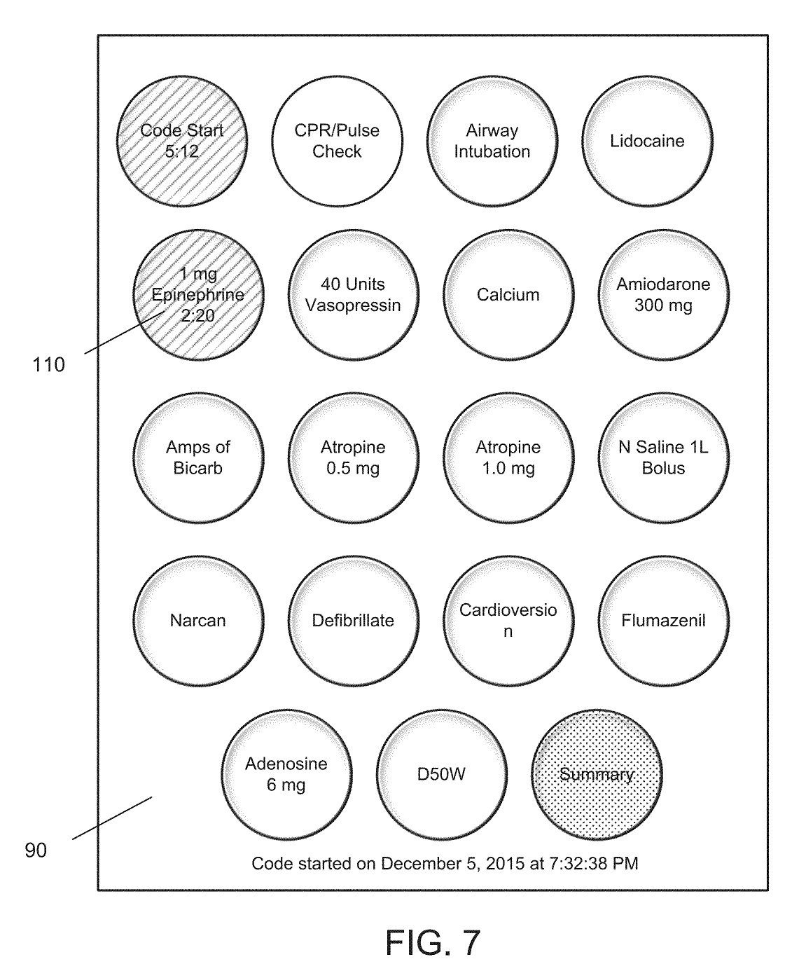

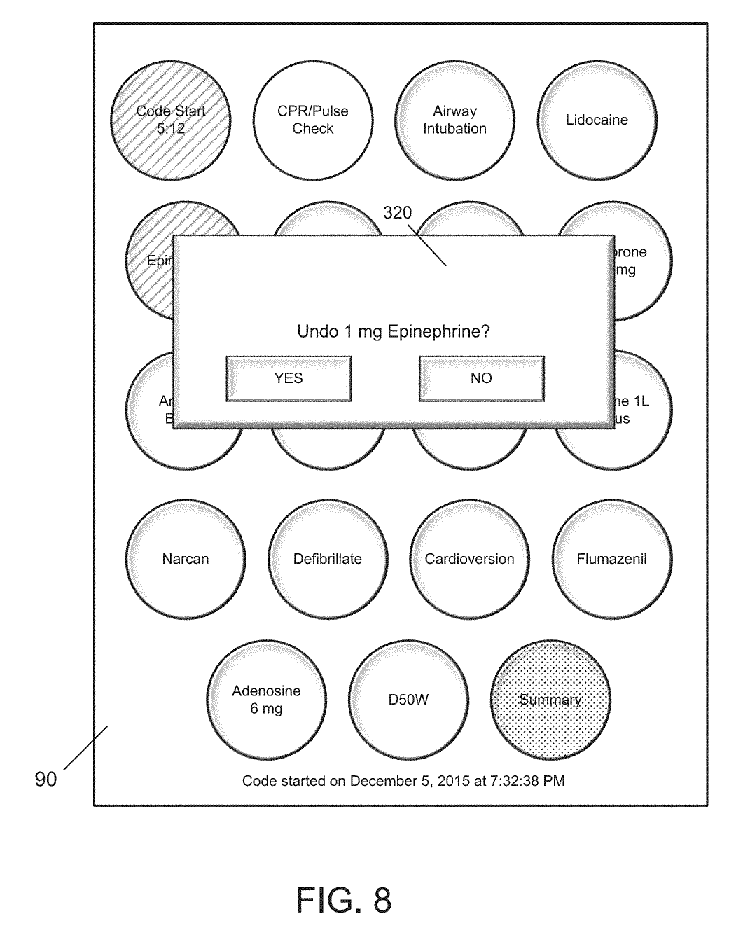

The ACLS protocol may include medications administered multiple times, where the administrations must be spaced in time from one another. Epinephrine is one such medication, where doses (in the current ACLS protocol) are to be spaced at least three minutes apart. FIG. 6 is a flowchart showing one manner in which the system 10 may operate regarding such medications. FIG. 7 and FIG. 8 show screens that may be presented in response to the operations executed in the flowchart of FIG. 6.

Referring to FIG. 6, the user actuates the epinephrine button 110 at operation 230 in response to the administration of 1 mg of epinephrine by the emergency team. At operation 240, the system 10 determines whether the user executed a long press. If a long press has not been executed by the user, the administration of the epinephrine and the time at which the epinephrine button was actuated is stored at operation 250. The appearance of the epinephrine button is changed at operation 260 (see also FIG. 7). At operation 270, a countdown timer is set and the timer value is displayed proximate the epinephrine button 110. A check is made at operation 280 to determine whether the countdown is complete. If the countdown is not complete, the countdown continues at operation 290 and the display of the timer value is updated at the epinephrine button 110. If the countdown is complete, the appearance of the epinephrine button 110 is changed at operation 300 to indicate that another dose of epinephrine may be given to the patient.

If the check at operation 240 indicates that the user has executed a long press of the epinephrine button 110, the system must determine whether the user accidentally actuated the button at operation 310. Accordingly, the user is presented with the option to undo the button press at a selection box 320 (see FIG. 8). If the user wishes to undo the button press, the appearance of the epinephrine button 110 is changed to its prior state at operation 330. Otherwise, control of the operations responsive to the actuation of the button is transferred to operation 250.

The ACLS protocol may also include various actions to be taken by the emergency team during the code blue event. Screen 90 shows several such action buttons, including: CPR/Pulse check button 340, defibrillator button 350, cardioversion button 360, and airway intubation button 370. Some actions, such as airway intubation, are typically administered once. In such cases, the appearance of the airway intubation button 370 may be changed when actuated, while the elapsed time since the intubation took place is displayed proximate the airway intubation button 370.

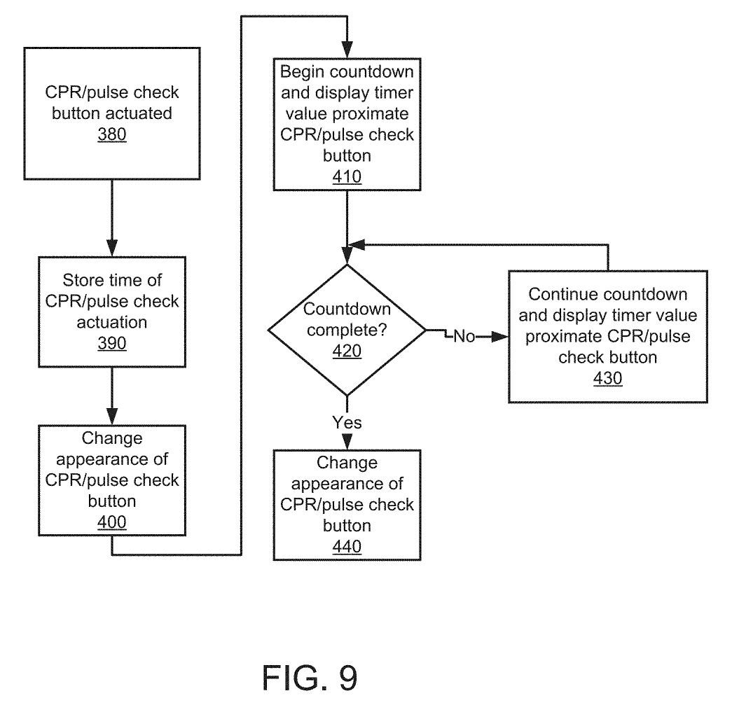

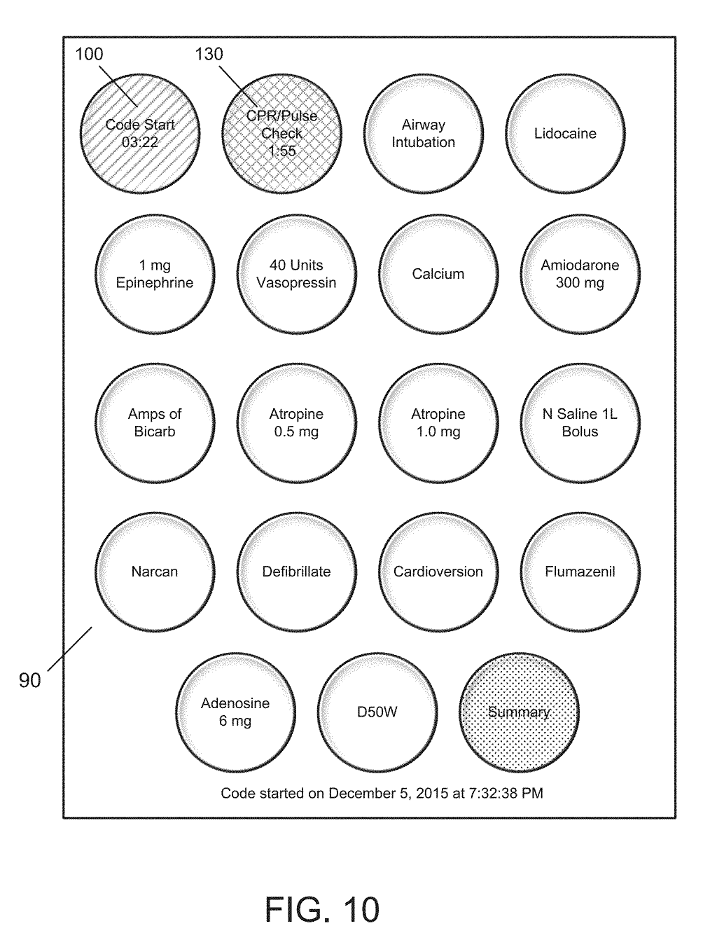

In other instances, actions may be taken multiple times by the emergency team. This is the case, for example, for CPR and pulse checks executed under the ACLS protocol. FIG. 9 is a flowchart showing one manner in which the system 10 may operate regarding actions like CPR. FIG. 10 shows a screen that may be presented in response to the operations executed in the flowchart of FIG. 9.

Referring to FIG. 9, the emergency team actuates the CPR/Pulse check button 130 at operation 380 when starting CPR. The CPR action and time at which CPR is started is stored at operation 390. The appearance of the CPR/Pulse check button 130 is changed at operation 400 (see FIG. 10). A countdown timer is started at operation 410 and is displayed proximate the CPR/Pulse check button 130. The countdown timer is used to determine when the emergency team is to conduct a pulse check. A determination of whether the countdown is complete occurs at operation 420. If the countdown is not complete, the countdown is continued at operation 430 and the timer value displayed proximate the CPR/Pulse check button is updated. Once the countdown is complete, the appearance of the CPR/Pulse check button 130 is changed at operation 440 to indicate that the emergency team is to execute a pulse check. If CPR is to be continued, the CPR/Pulse check button 130 is actuated again at operation 380, restarting the remaining operations shown in FIG. 9.

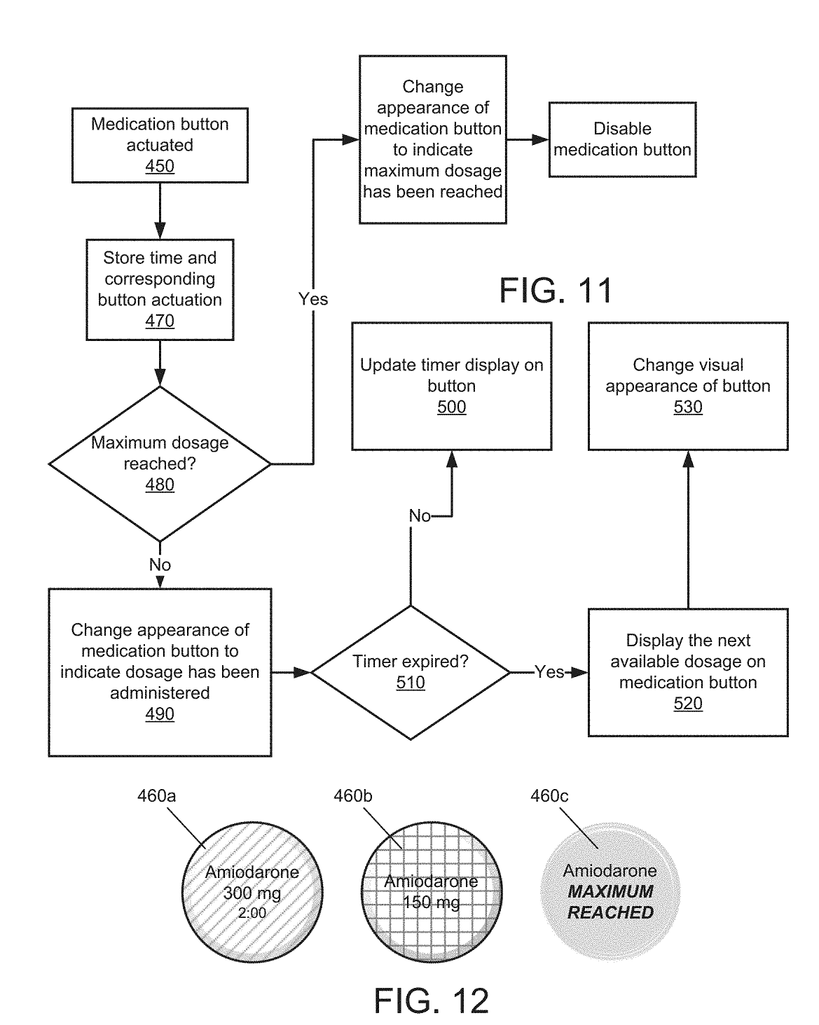

The ACLS protocol may include medications that are administered multiple times, but are administered at different dosages each time. Also, some medications may be administered multiple times, but have a limit on the total amount of medication that may be administered. FIG. 11 is a flowchart showing one manner in which the system 10 may handle such medications. In FIG. 11, the same medication button is used for multiple doses of that medication. FIG. 12 is an example of how the appearance of the button may change with the administration of each dose. Here, the medication amiodarone is used for the example. Amiodarone is administered in the ACLS protocol at different doses. The first dose is 300 mg, and the second dose is 150 mg. No further doses of amiodarone may be given once the total 450 mg has been reached.

Referring to FIG. 11, the medication button, such as the amiodarone button 460, is actuated at operation 450 when the emergency team administers the medication. At operation 470, the system stores the type of medication administered as well as the time at which the corresponding button was actuated. A check is made at operation 480 to determine whether the maximum dosage of medication has been reached. If not, the appearance of the medication button 460a is changed at operation 490 to indicate that the dosage has been administered. The time between dosages of the medication may be monitored by a timer, which is displayed proximate the medication button at operation 500 (see medication button 460a of FIG. 12). If it is determined at operation 510 that the timer has not expired the countdown continues and the display of the timer is updated. If the timer has expired at operation 510, the medication button is changed at operation 520 to display the amount of the next dosage (see medication button 460b of FIG. 12). Further, the appearance of the medication button may be changed at operation 530 to indicate that the next dosage is available (see medication button 460b of FIG. 12).

When medication button 460b has been actuated, the process starts again from operation 450 and the actuation of the button as well as the time at which the second dose was administered is stored at operation 470. A check is made at operation 480 to determine whether the total allowable amount of medication has been administered. Here, in the case of amiodarone, a total of 450 mg has been administered, which is the maximum amount allowable in the ACLS protocol. Accordingly, the appearance of the medication button is changed at operation 540 to indicate the maximum dosage has been reached (see medication button 460c of FIG. 12). The medication button may be disabled at operation 550.

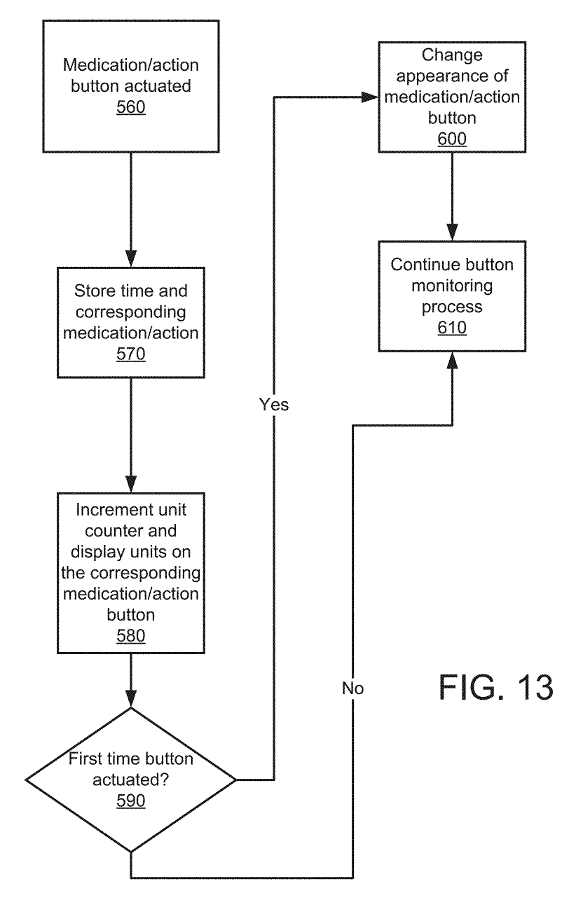

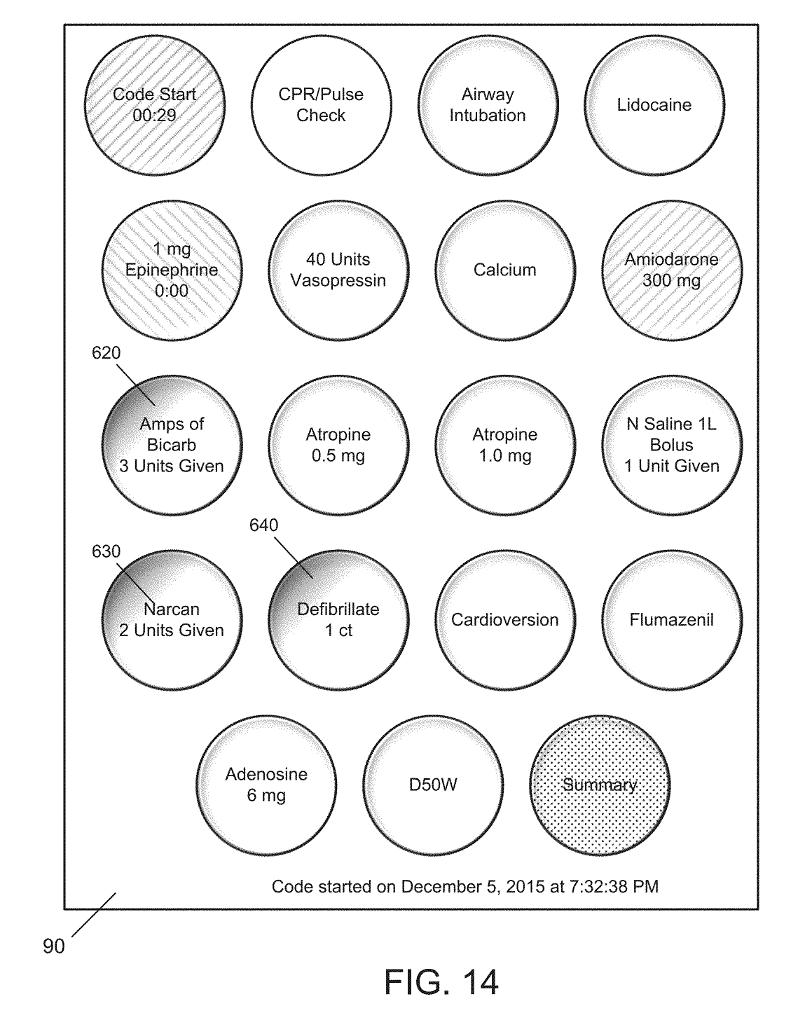

In some instances, the emergency team needs to be aware of the number of times/units of medication has been administered. Additionally, or in the alternative, the emergency team may need to be aware of the number of times a particular action has been taken. FIG. 13 is a flowchart showing one manner in which the system 10 may handle such medications/actions. FIG. 14 is a screen showing various results of the operations of FIG. 13.

Referring to FIG. 13, the medication/action button is actuated at operation 560. The actuation of the medication/action button and the time at which the medication/action button was actuated is stored at operation 570. Medication/action buttons operating in this manner may each have respective counters. At operation 580, the counter is implemented in the total number of units/dosages are displayed on the corresponding medication/action button. A determination may be made at operation 590 whether this is the first time the button has been actuated. If so, the appearance of the medication/action button may be changed at operation 600. Otherwise, the button monitoring process may be continued at operation 610.

FIG. 14 shows a screen 90 that may be displayed when actuation of the medication/action buttons are handled in the manner shown in FIG. 13. Here, the system has monitored amps of bicarbonate at medication button 620, the number of narcan units given at medication button 630, and the number of times the patient has been defibrillated at action button 640. As shown on the respective buttons, three units of bicarbonate have been given, two units of narcan have been given, and the patient has been defibrillated once.

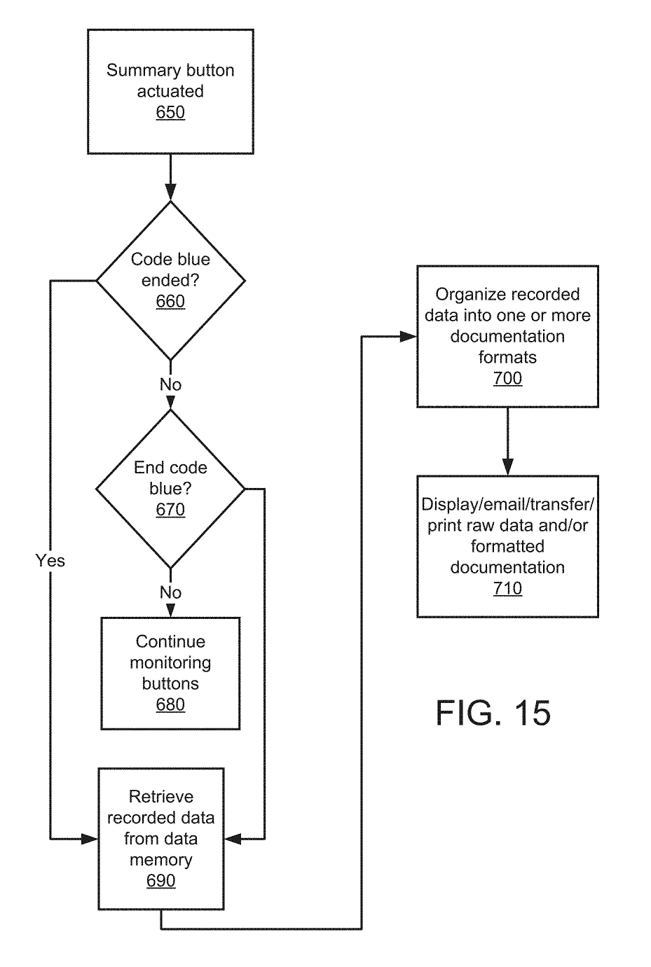

FIG. 15 is a flowchart showing one manner in which the system may respond to actuation of the summary button 120. As shown, the summary button 120 is actuated at operation 650. A check is made at operation 660 to determine whether the code blue event has been ended by the emergency team. If the emergency team has not terminated the code blue event, they may be prompted to end the event at operation 670. If the emergency team does not terminate the code blue event or has not previously terminated the code blue event, the system will continue to monitor the buttons at operation 680 as though the summary button 120 had not been actuated.

If the code blue event has been terminated as determined at operation 660, or the emergency team ends the code blue event at operation 670, the data recorded during the code blue event is retrieved from data memory 80 at operation 690. The raw data may be transferred directly to, for example, another individual and/or server 50. Additionally, or in the alternative, the system may organize the recorded data into one or more documentation formats at operation will 700. The documentation formats may include the start and end time of the code blue event, the medications used during the event and the times at which each medication was administered, the actions taken during the event and the times at which each action was taken, as well as any other information that may be derived from the data stored in data memory 80. At operation 710, the raw data and/or formatted documentation may be displayed as a new page on the screen 90 along with options to email, print, or otherwise transfer the data and/or formatted documentation from the system 10.

Other modifications and implementations will occur to those skilled in the art without departing from the spirit and the scope of the invention as claimed. Accordingly, the above description is not intended to limit the invention, except as indicated in the following claims.

What is claimed is:

1. An apparatus for documenting Advanced Cardiac Life Support (ACLS) procedures during a code blue event, the apparatus comprising:
a touch screen display;
a processor; and
electronic memory storage including instructions executable by the processor, wherein the instructions, the processor, and the touch screen display cooperate to:
provide a code blue event start button on the touch screen display, actuation of the code blue event start button recording a start time of the code blue event in the electronic memory storage,
provide a plurality of medication buttons on the touch screen display, the plurality of medication buttons corresponding to respective medications administered as part of an ACLS procedure, actuation of a medication button recording a time at which the respective medication was administered, wherein the actuation of the medication button further results in a change in a visual appearance of the medication button, and
provide a summary button on the touch screen display, actuation of the summary button displaying a summary page including at least a start time of the code blue event and times at which medications for the ACLS procedure were administered.

2. The apparatus of claim 1, wherein the change in visual appearance of the medication button includes displaying a number of times the respective medication has been delivered.

3. The apparatus of claim 1, wherein actuation of the medication button starts a timer indicating when a next dose of the respective medication may be administered.

4. The apparatus of claim 3, wherein the visual appearance of the medication button changes when a next dose of the respective medication may be administered.

5. The apparatus of claim 4, wherein the visual appearance of the medication button shows an amount of the respective medication to be administered as the next dose in the ACLS procedure.

6. The apparatus of claim 3, wherein visual indicia corresponding to the timer is displayed proximate the medication button.

7. The apparatus of claim 1, wherein the instructions, processor, and touch screen display further cooperate to:
provide a plurality of action buttons on the touch screen display, the plurality of action buttons corresponding to respective actions taken as part of the ACLS procedure, actuation of an action button recording a time at which the respective action was taken as part of the ACLS procedure, wherein actuation of the summary button on the touch screen display accesses times at which the respective actions were taken.

8. The apparatus of claim 7, wherein at least one action button includes visual indicia corresponding to an elapsed time since actuation of the at least one action buttons.

9. The apparatus of claim 7, wherein the plurality of action buttons include a CPR/pulse check button.

10. The apparatus of claim 7, wherein the plurality of action buttons include an airway intubation button.

11. The apparatus of claim 7, wherein the plurality of action buttons include a defibrillate button.

12. The apparatus of claim 7, wherein the plurality of action buttons include a cardioversion button.

13. The apparatus of claim 1, wherein the instructions and the processor further cooperate to wirelessly transmit at least a portion of data included in the summary page to another device.

14. The apparatus of claim 1, wherein the instructions, processor, and touch screen display further cooperate to email at least a portion of data included in the summary page.

15. The apparatus of claim 1, wherein the code blue event start button includes visual indicia corresponding to elapsed time of the code blue event.

16. The apparatus of claim 1, wherein the code blue start event button and plurality of medication buttons are all displayed on a single page of the touch screen display.

17. A software program for documenting Advanced Cardiac Life Support (ACLS) procedures during a code blue event, the software program including instructions executable by a processor to provide:
a code blue event start button on a touch screen display, actuation of the code blue event start button recording a start time of the code blue event in electronic memory storage, actuation of the code blue event further displaying visual indicia indicative of an elapsed time since the start time of the code blue event;
a plurality of medication buttons on the touch screen display corresponding to respective medications administered as part of an ACLS procedure, actuation of a medication button recording a time at which the respective medication was administered in the electronic memory storage, wherein the actuation of the medication button further results in a change in a visual appearance of the medication button; and
a summary button on the touch screen display, actuation of the summary button accessing the electronic memory storage to display a summary page including at least a start time of the code blue event and times at which medications for the ACLS procedure were administered.

18. The software program of claim 17, wherein the instructions and the processor further cooperate to interact with the touch screen display to:
provide a plurality of action buttons on the touch screen display, the plurality of action buttons corresponding to respective actions taken as part of the ACLS procedure, actuation of an action button recording a time at which the respective action was taken as part of the ACLS procedure in the electronic memory storage, wherein actuation of the summary button on the touch screen display accesses times at which the respective actions were taken from the electronic memory storage.

19. The software program of claim 18, wherein at least one action button includes visual indicia corresponding to an elapsed time since actuation of the at least one action button.

20. A method for documenting Advanced Cardiac Life Support (ACLS) procedures during a code blue event, the method comprising:
actuating a code blue event start button on a touch screen display, actuation of the code blue event start button recording a start time of the code blue event in electronic memory storage;
actuating a plurality of medication buttons on the touch screen display, the plurality of medication buttons corresponding to respective medications administered as part of the ACLS procedure, actuation of a medication button recording a time at which the respective medication was administered in the electronic memory storage, wherein the actuation of the medication button further results in a change in a visual appearance of the medication button; and
actuating a summary button on the touch screen display, actuation of the summary button accessing the electronic memory storage to provide a summary page including at least a start time of the code blue event and times at which medications for the ACLS procedure were administered.
